(19) United States
(12) Patent Application Publication
(10) Pub. No.: US 2023/0098601 A1
(43) Pub. Date: Mar. 30, 2023

(54) DEVICE AND METHOD FOR HEATING A FLUID IN A PIPELINE WITH SINGLE-PHASE ALTERNATING CURRENT

(71) Applicants: BASF SE, Ludwigshafen an Rhein (DE); Linde GmbH, Pullach (DE)

(72) Inventors: Andrey SHUSTOV, Ludwigshafen am Rhein (DE); Sric JENNE, Ludwigshafen an Rhein (DE); Kiara Aenne KOCHENDOERFER, Ludwigshafen an Rhein (DE)

(21) Appl. No.: 17/798,909

(22) PCT Filed: Feb. 12, 2021
(86) PCT No.: PCT/EP2021/053403

§ 371 Date: Aug. 11, 2022

(30) Foreign Application Priority Data
Feb. 14, 2020 (EP) 20157516.4

(51) Int. Cl. H05B 3/42

(52) U.S. Cl. CPC H05B 3/42; H05B 2203/005; H05B 2203/021; H05B 2203/022; H05B 2214/03

(57) ABSTRACT

An apparatus (100) for heating a fluid is proposed. The apparatus comprises
at least one electrically conductive pipeline (112) and/or at least one electrically conductive pipeline segment (114) for receiving the fluid, and
at least one single-phase AC power source and/or at least one single-phase AC voltage source (126), each pipeline (112) and/or each pipeline segment (114) being assigned a sin-gle-phase AC power source and/or a single-phase AC voltage source (126) which is connected to the respective pipeline (112) and/or to the respective pipeline segment (114), the respective single-phase AC power source and/or single-phase AC voltage source (126) being designed to generate an electrical current in the respective pipeline (112) and/or in the respective pipeline segment (114), which warms up the respective pipeline (112) and/or the respective pipeline segment (114) by Joulean heat, which is produced when the electrical current passes through conducting pipe material, for heating the fluid, the single-phase AC power source and/or the single-phase AC voltage source (126) being connected to the pipeline (112) and/or the pipeline segment (114) in an electrically conducting manner in such a way that the alternating current generated flows into the pipeline (112) and/or the pipeline segment (114) via a forward conductor (128) and flows back to the AC power source and/or AC voltage source (126) via a return conductor (130).

The invention relates to an apparatus and a method for heating a fluid in a pipeline.

Such apparatuses are known in principle. For example, WO 2015/197181 A1 describes an apparatus for heating a fluid with at least one electrically conductive pipeline for receiving the fluid, and at least one voltage source connected to the at least one pipeline. The at least one voltage source is designed for generating in the at least one pipeline an electrical alternating current, which warms up the at least one pipeline for heating the fluid.

However, known apparatuses for heating a fluid in a pipeline are often technically complex or can only be implemented with great technical effort.

FR 2 722 359 A1 describes that a liquid flows through a uniform central bore of a channel of a wall thickness which uniformly increases axially. A source of electrical energy is connected between the ends. The resistance heating per unit length decreases with increasing thickness, the required energy distribution being achieved by choosing suitable dimensions.

WO 2013/143435 A1 describes an electrical high-frequency heating material pipe, consisting of a pipe body made of conductive material, which fits together with at least one group of heating devices. The heating devices are arranged on the material pipe body and exter-nally connected to a high-frequency AC power supply. The heating device comprises at least two conductive components. The two conductive components are each provided with a conductive ring. The conductive rings are each pushed onto the material pipe body and arranged separately on the left side and right side. The two conductive rings are each connected to a conductive wire and the other ends of the two conductive wires are each connected to the different electrodes of the high-frequency AC power supply to conduct the high-frequency current to the surface of the material pipe body and collect it so that the high-frequency alternating current flows on the surface of the material pipe body and the temperature rises rapidly to warm up the surface of the material pipe body due to the presence of an impedance.

In the technical field of undersea pipelines, as described in EP 3 579 659 A1, an undersea direct electrical heating energy supply system for providing electrical energy for heating an undersea pipeline section is known. The system comprises input means adapted to couple the direct electrical heating energy supply system to a power supply and a submarine variable speed drive for receiving electrical energy from the input means and providing an AC output.

A pipeline heating system comprising a thermally insulated pipeline in which part of the pipeline acts as a heating element is known in the technical field of oil pipelines, as described in GB 2 341 442 A. The heating element has connections with corresponding supply and return cables at opposite ends of the length of the pipeline defining the heating element, with the thermal insulation providing electrical insulation for the heating element.

It is therefore the object of the present invention to provide an apparatus and a method for heating a fluid which at least largely avoid the disadvantages of known apparatuses and methods. In particular, the apparatus and the method should be technically simple to imple-ment and carry out and also be economical. In particular, the apparatus and the method should be able to be used for the heating of fluids which cause a reduction in insulation, for example coking in cracking furnaces.

This object was achieved by an apparatus with the features of the independent claims. Preferred configurations of the invention are specified inter alia in the associated subclaims and dependency references of the subclaims.

In the following, the terms “have”, “comprise” or “include” or any grammatical variations thereof are used in a non-exclusive way. Accordingly, these terms may relate to situations in which there are no further features apart from the feature introduced by these terms or to situations in which there is or are one or more further features. For example, the expression “A has B”, “A comprises B” or “A includes B” may relate both to the situation in which, apart from B, there is no further element in A (i.e. to a situation in which A exclusively consists of B) and to the situation in which, in addition to B, there is or are one or more further elements in A, for example element C, elements C and D or even further elements.

It is also pointed out that the terms “at least one” and “one or more” and grammatical variations of these terms or similar terms, when these are used in connection with one or more elements or features and are intended to express that the element or feature may be provided one or more times, are generally only used once, for example when the feature or element is introduced for the first time. When the feature or element is subsequently mentioned again, the corresponding term “at least one” or “one or more” is generally no longer used, without restricting the possibility that the feature or element may be provided one or more times.

Furthermore, in the following the terms “preferably”, “in particular”, “for example” or similar terms are used in connection with optional features, without alternative embodiments being restricted. Thus, features that are introduced by these terms are optional features, and it is not intended to restrict the scope of protection of the claims, and in particular of the independent claims, by these features. Thus, as the person skilled in the art will appreciate, the invention can also be carried out by using other configurations. In a similar way, features that are introduced by “in an embodiment of the invention” or by “in an example of the invention” are understood as optional features, without it being intended that alternative configurations or the scope of protection of the independent claims are restricted thereby. Furthermore, all of the possibilities of combining the features thereby introduced with other features, whether optional or non-optional features, are intended to remain unaffected by these introductory expressions.

In a first aspect of the present invention, an apparatus for heating a fluid is proposed.

Within the scope of the present invention, a “fluid” is understood as meaning a gaseous and/or liquid medium. The fluid may for example be selected from the group consisting of: water, steam, a combustion air, a hydrocarbon mixture, a hydrocarbon to be cracked. For example, the fluid may be a hydrocarbon to be thermally cracked, in particular a mixture of hydrocarbons to be thermally cracked. For example, the fluid may be water or steam and additionally comprise a hydrocarbon to be thermally cracked, in particular a mixture of hydrocarbons to be thermally cracked. The fluid may for example be a preheated mixture of hydrocarbons to be thermally cracked and steam. Other fluids are also conceivable.

“Heating a fluid” may be understood as meaning a process that leads to a change in a temperature of the fluid, in particular to a rise in the temperature of the fluid, for example to a warming up of the fluid. For example, by the heating, the fluid may be warmed up to a prescribed or predetermined temperature value. For example, the fluid may be heated to a temperature in the range of 200° C. to 1200° C. The temperature range may be dependent on an application. For example, the fluid may be heated to a temperature in the range of 550° C. to 1100° C. For example, the fluid may be heated to a temperature in the range of 200° C. to 800° C., preferably of 400° C. to 700° C.

The apparatus may be part of an installation. For example, the installation may be selected from the group consisting of: a steam cracker, a steam reformer, a device for alkane dehydrogenation, a device for dry reforming. For example, the installation may be designed for carrying out at least one process selected from the group consisting of: steam cracking, steam reforming, alkane dehydrogenation, dry reforming.

The apparatus may for example be part of a steam cracker. “Steam cracking” may be understood as meaning a process in which longer-chain hydrocarbons, for example naphtha, propane, butane and ethane, as well as gas oil and hydrowax, are converted into short-chain hydrocarbons by thermal cracking in the presence of steam. In steam cracking, hydrogen, methane, ethene and propene can be produced as the main product, as well as inter alia butenes and pyrolysis benzene. The steam cracker may be designed for warming up the fluid to a temperature in the range of 550° C. to 1100° C.

For example, the apparatus may be part of a reformer furnace. “Steam reforming” may be understood as meaning a process for producing hydrogen and carbon oxides from water and carbon-containing energy carriers, in particular hydrocarbons such as natural gas, light gas-oline, methanol, biogas or biomass. For example, the fluid may be warmed up to a temperature in the range of 200° C. to 800° C., preferably of 400° C. to 700° C.

For example, the apparatus may be part of a device for alkane dehydrogenation. “Alkane dehydrogenation” may be understood as meaning a process for producing alkenes by dehydrogenating alkanes, for example dehydrogenating butane into butenes (BDH) or dehydrogenating propane into propene (PDH). The device for alkane dehydrogenation may be designed for warming up the fluid to a temperature in the range of 400° C. to 700° C.

However, other temperatures and temperature ranges are also conceivable.

The apparatus comprises:
at least one electrically conductive pipeline and/or at least one electrically conductive pipeline segment for receiving the fluid, and
at least one single-phase AC power source and/or at least one single-phase AC voltage source, each pipeline and/or each pipeline segment being assigned a single-phase AC power source and/or a single-phase AC voltage source which is connected to the respective pipeline and/or to the respective pipeline segment, the respective single-phase AC power source and/or single-phase AC voltage source being designed to generate an electrical current in the respective pipeline and/or in the respective pipeline segment, which warms up the respective pipeline and/or the respective pipeline segment by Joulean heat, which is produced when the electrical current passes through conducting pipe material, for heating the fluid, the single-phase AC power source and/or the single-phase AC voltage source being connected to the pipeline and/or the pipeline segment in an electrically conducting manner in such a way that the alternating current generated flows into the pipeline and/or the pipeline segment via a forward conductor and flows back to the AC power source and/or AC voltage source via a return conductor.

Within the scope of the present invention, a pipeline may be understood as meaning any shaped device designed to receive and transport the fluid. A pipeline segment may be understood as meaning a part of a pipeline. The pipeline may comprise at least one symmetrical pipe and/or at least one asymmetrical pipe. The geometry and/or surfaces and/or material of the pipeline may be dependent on a fluid to be transported.

An “electrically conductive pipeline” may be understood as meaning that the pipeline, in particular the material of the pipeline, is designed for conducting electrical current.

The fluid can flow through the respective pipelines and/or pipeline segments of the apparatus and be heated in them by the pipelines and/or pipeline segments being heated by an alternating current impressed in these pipelines and/or pipeline segments from the AC power and/or AC voltage sources, so that Joulean heat is generated in the pipelines and/or pipeline segments and is transferred to the fluid so that it is heated when it flows through the pipelines and/or pipeline segments.

The pipeline may be designed as a reaction pipe of a reformer furnace. The pipeline may be designed as a reaction pipe of at least one installation selected from the group consisting of: a steam cracker, a steam reformer, a device for alkane dehydrogenation, a device for dry reforming.

The apparatus may comprise a plurality of pipelines and/or pipeline segments. The apparatus may comprise L pipelines and/or pipeline segments, where L is a natural number greater than or equal to two. For example, the apparatus may comprise at least two, three, four, five or even more pipelines and/or pipe segments. The apparatus may for example comprise up to a hundred pipelines and/or pipeline segments. The pipelines and/or pipeline segments may be configured identically or differently.

The pipelines and/or pipeline segments may comprise symmetrical and/or asymmetrical pipes and/or combinations thereof. In a purely symmetrical configuration, the apparatus may comprise pipelines and/or pipeline segments of an identical type of pipe. “Asymmetrical pipes” and “combinations of symmetrical and asymmetrical pipes” may be understood as meaning that the apparatus may comprise any combination of types of pipe, which may for example also be connected as desired in parallel or in series. A “type of pipe” may be understood as meaning a category or type of pipeline and/or pipeline segment characterized by certain features. The type of pipe may be characterized at least by one feature selected from the group consisting of: a horizontal configuration of the pipeline and/or the pipeline segment; a vertical configuration of the pipeline and/or the pipeline segment; a length in the inlet (L1) and/or outlet (L2) and/or transition (L3); a diameter in the inlet (d1) and outlet (d2) and/or transition (d3); the number n of passes; the length per pass; the diameter per pass; the geometry; the surface; and the material. The apparatus may comprise a combination of at least two different types of pipe which are connected in parallel and/or in series. For example, the apparatus may comprise pipelines and/or pipeline segments of different lengths in the inlet (L1) and/or outlet (L2) and/or transition (L3). For example, the apparatus may comprise pipelines and/or pipeline segments with an asymmetry of the diameters in the inlet (d1) and/or outlet (d2) and/or transition (d3). For example, the apparatus may comprise pipelines and/or pipeline segments with a different number of passes.

For example, the apparatus may comprise pipelines and/or pipeline segments with passes with different lengths per pass and/or different diameters per pass. In principle, any combinations of all types of pipe in parallel and/or in series are possible. The apparatus may comprise a plurality of feed inlets and/or feed outlets and/or production streams. “Feed” may be understood as meaning a stream of material which is fed to the apparatus. The pipelines and/or pipeline segments of different or identical types of pipe may be arranged in parallel and/or in series with a plurality of feed inlets and/or feed outlets. Pipelines and/or pipeline segments can be present in various types of pipe in the form of a construction kit and may be selected and combined as desired, dependent on an intended use. By using pipelines and/or pipeline segments of different types of pipe, more accurate temperature control and/or an adaptation of the reaction when there is a fluctuating feed and/or a selective yield of the reaction and/or an optimized process technology can be made possible. The pipelines and/or pipeline segments may comprise identical or different geometries and/or surfaces and/or materials. The pipelines and/or pipeline segments may be through-connected, and thus form a pipe system for receiving the fluid. A “pipe system” may be understood as meaning a device comprising at least two pipelines and/or pipeline segments, in particular connected to one another. The pipe system may comprise incoming and outgoing pipelines. The pipe system may comprise at least one inlet for receiving the fluid. The pipe system may comprise at least one outlet for discharging the fluid. “Through-connected” may be understood as meaning that the pipelines and/or pipeline segments are in fluid connection with one another. Thus, the pipelines and/or pipeline segments may be arranged and connected in such a way that the fluid flows through the pipelines and/or pipeline segments one after the other. The pipelines and/or pipeline segments may be connected parallel to one another in such a way that the fluid can flow through at least two pipelines and/or pipeline segments in parallel. The pipelines and/or pipeline segments, in particular the pipelines and/or pipeline segments connected in parallel, may be designed in such a way as to transport different fluids in parallel. In particular, the pipelines and/or pipeline segments connected in parallel may comprise geometries and/or surfaces and/or materials that are different from one another for transporting different fluids. In particular for the transport of a fluid, a number or all of the pipelines and/or pipeline segments may be configured as parallel, so that the fluid can be divided among those pipelines configured as parallel. Combinations of a series connection and a parallel connection are also conceivable.

The pipelines and/or pipeline segments and correspondingly incoming and outgoing pipelines may be connected to one another in a fluid-conducting manner, while the pipelines and/or pipeline segments and the incoming and outgoing pipelines can be galvanically separated from one another. “Galvanically separated from one another” may be understood as meaning that the pipelines and/or pipeline segments and the incoming and outgoing pipelines are separated from one another in such a way that there is no electrical conduction and/or a tolerable electrical conduction between the pipelines and/or pipeline segments and the incoming and outgoing pipelines. The apparatus may comprise at least one isolator, in particular a plurality of isolators. The galvanic separation between the respective pipelines and/or pipeline segments and the incoming and outgoing pipelines can be ensured by the isolators. The isolators can ensure a free flow of the fluid. For the respective galvanically separated pipelines and/or pipeline segments, the apparatus may comprise at least one forward conductor and at least one return conductor. The forward conductor and the return conductor for the respective galvanically separated pipelines and/or pipeline segments may be connected to an AC power source and/or an AC voltage source. An AC power source and/or an AC voltage source, at least one forward conductor and at least one return conductor may thus be provided for each of the respective galvanically separated pipelines and/or pipeline segments.

An “AC power source” may be understood as meaning a power source designed to provide an alternating current. An “alternating current” may be understood as meaning an electrical current of a polarity which changes in a regular repetition. For example, the alternating current may be a sinusoidal alternating current. A “single-phase” AC power source may be understood as meaning an AC power source which provides an electrical current with a single phase.

The apparatus may be designed to apply the alternating current to the pipeline and/or the pipeline segment and/or to provide the alternating current for the pipeline and/or for the pipeline segment. The apparatus may comprise a forward conductor, which is designed to conduct the alternating current generated to a further element, in particular the pipeline and/or the pipeline segment, in such a way that the alternating current generated flows into the pipeline and/or the pipeline segment via the forward conductor. A “forward conductor” may be understood as meaning any electrical conductor, in particular a feeder, the “forward” part of the term indicating a direction of flow from the AC power source or AC voltage source in relation to that of the pipeline and/or the pipeline segment.

An “AC voltage source” may be understood as meaning a voltage source which is designed to provide an AC voltage. An “AC voltage” may be understood as meaning a voltage of a level and polarity which are repeated regularly over time. For example, the AC voltage may be a sinusoidal AC voltage. The voltage generated by the AC voltage source causes a current to flow, in particular an alternating current to flow. A “single-phase” AC voltage source may be understood as meaning an AC voltage source which provides the alternating current with a single phase.

The AC power source and/or the AC voltage source are designed to generate an alternating current in the respective pipeline and/or the respective pipeline segment. The alternating current generated can warm up the respective pipeline and/or the respective pipeline segment by Joulean heat, which is produced when the electrical current passes through conducting pipe material, for heating the fluid. “Warming up the pipeline and/or the pipeline segment” may be understood as meaning a process that leads to a change in a temperature of the pipeline and/or the pipeline segment, in particular a rise in the temperature of the pipeline and/or the pipeline segment.

The AC power source and/or AC voltage source is connected to the pipeline and/or the pipeline segment in an electrically conducting manner in such a way that the alternating current generated flows into the pipeline and/or the pipeline segment via the forward conductor and flows back to the AC power source and/or AC voltage source via a return conductor. The apparatus may comprise at least one return conductor. A “return conductor” may be understood as meaning any electrical conductor which is designed to carry away the alternating current after it has flowed through the pipeline and/or the pipeline segment, in particular to the AC power source or AC voltage source. The “return” part of the term indicates here a direction of flow from the pipeline and/or the pipeline segment to the AC power source or AC voltage source.

The apparatus may comprise a plurality of single-phase AC power or single-phase AC voltage sources.

Each of the pipelines and/or for each pipeline segment may be assigned an AC power source and/or AC voltage source, which is connected to the respective pipeline and/or to the respective pipeline segment, in particular electrically via at least one electrical connection. Also conceivable are embodiments in which at least two pipelines and/or for each pipeline segment share an AC power source and/or AC voltage source.

To connect the single-phase AC power or single-phase AC voltage sources and the respective pipelines and/or with the respective pipeline segments, the apparatus may comprise 2 to N forward conductors and 2 to N return conductors, where N is a natural number greater than or equal to three. The respective single-phase AC power source and/or AC voltage source may be designed to generate an electrical current in the respective pipeline and/or in the respective pipeline segment.

The AC power and/or AC voltage sources may either be controlled or uncontrolled. The AC power and/or AC voltage sources may be configured with or without the possibility of controlling at least one electrical output variable. An “output variable” may be understood as meaning a current and/or a voltage value and/or a current and/or a voltage signal. The apparatus may comprise 2 to M different AC power and/or AC voltage sources, where M is a natural number greater than or equal to three. The AC power and/or AC voltage sources may be electrically controllable independently of one another. For example, a different current may be generated in the respective pipelines and different temperatures reached in the pipelines.

Furthermore, the apparatus may comprise at least one heating wire, which may for example be wound around the pipeline and/or the pipeline segment. The AC power source and/or AC voltage source may be connected to the heating wire. The AC power source and/or AC voltage source may be designed to generate a current in the heating wire and thus to generate heat. The heating wire may be designed to warm up the pipeline and/or the pipeline segment, in particular to heat it.

In a further aspect, a method for heating a fluid is proposed within the scope of the present invention. An apparatus according to the invention is used in the method.

The method comprises the following steps:
providing at least one electrically conductive pipeline and/or at least one electrically conductive pipeline segment for receiving the fluid;
receiving the fluid in the pipeline and/or the pipeline segment;
providing at least one single-phase AC power source and/or at least one single-phase AC voltage source, each pipeline and/or each pipeline segment being assigned a single-phase AC power source and/or a single-phase AC voltage source which is connected to the respective pipeline and/or to the respective pipeline segment.
generating by the respective single-phase AC power source and/or single-phase AC voltage source an electrical current in the respective pipeline and/or in the respective pipeline segment, which warms up the respective pipeline and/or the respective pipeline segment by Joulean heat, which is produced when the electrical current passes through conducting pipe material, for heating the fluid, the single-phase AC power source and/or the single-phase AC voltage source being connected to the pipeline and/or the pipeline segment in an electrically conducting manner in such a way that the alternating current generated flows into the pipeline and/or the pipeline segment via a forward conductor and flows back to the AC power source and/or AC voltage source via a return conductor.

With regard to embodiments and definitions, can be made to the above description of the unit. The method steps may be carried out in the sequence specified, it also being possible for one or more of the steps to be carried out at least partially simultaneously and it being possible for one or more of the steps to be repeated a number of times. In addition, further steps may be additionally performed, irrespective of whether or not they have been mentioned in the present application.

The fluid can flow through the respective pipelines and/or pipeline segments of the apparatus and be heated in them by the pipelines being heated by an alternating current impressed in these pipelines and/or pipeline segments from the single-phase AC power source and/or the single-phase AC voltage source, so that Joulean heat is generated in the pipelines and/or pipeline segments and is transferred to the fluid so that it is heated when it flows through the pipelines and/or pipeline segments.

For example, as the fluid, a hydrocarbon to be thermally cracked, in particular a mixture of hydrocarbons to be thermally cracked, may be heated.

For example, as the fluid, water or steam may be heated, with said water or said steam being heated in particular to a temperature in the range of 550° C. to 700° C., and the fluid additionally comprising, in particular containing, a hydrocarbon to be thermally cracked, in particular a mixture of hydrocarbons to be thermally cracked. The fluid to be heated may be a preheated mixture of hydrocarbons to be thermally cracked and steam.

For example, as the fluid, combustion air of a reformer furnace may be preheated or heated, for example to a temperature in the range of 200° C. to 800° C., preferably 400° C. to 700° C.

For example, the pipeline may be formed as a reaction pipe of a reformer furnace.

The apparatus according to the invention and the method according to the invention have numerous advantages over known apparatuses and methods. The apparatus according to the invention and the method according to the invention allow closed-loop control of the temperature, closed-loop control of the current or voltage, optimization of the yield, any implementation of a reactor design and any combination of the reactors.

To sum up, the following embodiments are particularly preferred within the scope of the present invention:

Embodiment 1: An apparatus for heating a fluid comprising
at least one electrically conductive pipeline and/or at least one electrically conductive pipeline segment for receiving the fluid, and
at least one single-phase AC power source and/or at least one single-phase AC voltage source, each pipeline and/or each pipeline segment being assigned a single-phase AC power source and/or a single-phase AC voltage source which is connected to the respective pipeline and/or to the respective pipeline segment, the respective single-phase AC power source and/or single-phase AC voltage source being designed to generate an electrical current in the respective pipeline and/or in the respective pipeline segment, which warms up the respective pipeline and/or the respective pipeline segment by Joulean heat, which is produced when the electrical current passes through conducting pipe material, for heating the fluid, the single-phase AC power source and/or the single-phase AC voltage source being connected to the pipeline and/or the pipeline segment in an electrically conducting manner in such a way that the alternating current generated flows into the pipeline and/or the pipeline segment via a forward conductor and flows back to the AC power source and/or AC voltage source via a return conductor.

Embodiment 2: The apparatus according to the preceding embodiment, wherein the apparatus comprises a plurality of pipelines and/or pipeline segments, the pipelines and/or pipeline segments being through-connected and thus forming a pipe system for receiving the fluid.

Embodiment 3: The apparatus according to one of the preceding embodiments, wherein the apparatus comprises L pipelines and/or pipeline segments, where L is a natural number greater than or equal to two, the pipelines and/or pipeline segments comprising symmetrical or asymmetrical pipes and/or a combination thereof.

Embodiment 4: The apparatus according to one of the preceding embodiments, wherein the pipelines and/or pipeline segments and correspondingly incoming and outgoing pipelines are connected to one another in a fluid-conducting manner, the pipelines and/or pipe segments and the incoming and outgoing pipelines being galvanically separated from one another.

Embodiment 5: The apparatus according to the preceding embodiment, wherein the apparatus comprises isolators which are designed for galvanic separation between the respective pipelines and/or pipeline segments and the incoming and outgoing pipelines, the isolators being designed to ensure a free through-flow of the fluid.

Embodiment 6: The apparatus according to one of the preceding embodiments, wherein a number or all of the pipelines and/or pipeline segments are configured in series and/or in parallel.

Embodiment 7: The apparatus according to one of the preceding embodiments, wherein the apparatus comprises a plurality of single-phase AC power or single-phase AC voltage sources, the single-phase AC power or single-phase AC voltage sources being configured with or without the possibility of controlling at least one electrical output variable.

Embodiment 8: The apparatus according to the preceding embodiment, wherein, to connect the single-phase AC power or single-phase AC voltage sources and the respective pipelines and/or with the respective pipeline segments, the apparatus has 2 to N forward conductors and 2 to N return conductors, where N is a natural number greater than or equal to three.

Embodiment 9: Apparatus according to one of the two preceding embodiments, wherein the respective single-phase AC power or single-phase AC voltage sources are configured identically or differently.

Embodiment 10: The apparatus according to the preceding embodiment, wherein the apparatus comprises 2 to M different single-phase AC power and/or single-phase AC voltage sources, where M is a natural number greater than or equal to three, the single-phase AC power and/or single-phase AC voltage sources being electrically controllable independently of one another.

Embodiment 11: An installation comprising at least one apparatus according to one of the preceding embodiments.

Embodiment 12: The installation according to the preceding embodiment, wherein the installation is selected from the group consisting of: a steam cracker, a steam reformer, a device for alkane dehydrogenation, a device for dry reforming.

Embodiment 13: A method for heating a fluid using an apparatus according to one of the preceding embodiments relating to an apparatus, the method comprising the following steps:
providing at least one electrically conductive pipeline and/or at least one electrically conductive pipeline segment for receiving the fluid;
receiving the fluid in the pipeline and/or the pipeline segment;
providing at least one single-phase AC power source and/or at least one single-phase AC voltage source, each pipeline and/or each pipeline segment being assigned a single-phase AC power source and/or a single-phase AC voltage source which is connected to the respective pipeline and/or to the respective pipeline segment.
   generating by the respective single-phase AC power source and/or single-phase AC voltage source an electrical current in the respective pipeline and/or in the respective pipeline segment, which warms up the respective pipeline and/or the respective pipeline segment by Joulean heat, which is produced when the electrical current passes through conducting pipe material, for heating the fluid, the single-phase AC power source and/or the single-phase AC voltage source being connected to the pipeline and/or the pipeline segment in an electrically conducting manner in such a way that the alternating current generated flows into the pipeline and/or the pipeline segment via a forward conductor and flows back to the AC power source and/or AC voltage source via a return conductor.

Embodiment 14: The method according to the preceding embodiment, wherein, as the fluid, a hydrocarbon to be thermally cracked, in particular a mixture of hydrocarbons to be ther-malty cracked, is heated.

Embodiment 15: The method according to one of the preceding embodiments relating to a method, wherein, as the fluid, water or steam is heated, with said water or said steam being heated in particular to a temperature in the range of 550° C. to 700° C., and the fluid additionally comprising a hydrocarbon to be thermally cracked, in particular a mixture of hydrocarbons to be thermally cracked, the fluid to be heated being a preheated mixture of hydrocarbons to be thermally cracked and steam.

Embodiment 16: The method according to one of the preceding embodiments relating to a method, wherein, as the fluid, combustion air from a reformer furnace is preheated, for example to a temperature in the range of 200° C. to 800° C., preferably 400° C. to 700° C.

### BRIEF DESCRIPTION OF THE FIGURES

Further details and features of the invention may be found in the following description of preferred examples, in particular in conjunction with the subclaims. The respective features may be implemented separately, or several of them may be implemented in combination with one another. The invention is not restricted to the examples. The examples are diagrammat-ically represented in the figures. References which are the same in the individual figures de-note elements which are the same or have the same function, i.e. they correspond to one another in respect of their functions.

Specifically:

FIGS. 1a to 1c show schematic representations of examples of an apparatus according to the invention;

FIG. 2 shows a schematic representation of a further example of the apparatus according to the invention;

FIGS. 3a and 3b show schematic representations of further examples of the apparatus according to the invention;

FIGS. 4a to 4c show schematic representations of examples of an apparatus according to the invention;

FIG. 5 shows a schematic representation of a further example of the apparatus according to the invention;

FIGS. 6a and 6f show schematic representations of further examples of the apparatus according to the invention;

FIGS. 7Ai to Cvi show a schematic representation of types of pipe; and

FIGS. 8a to y show a construction kit with types of pipe and examples according to the invention of combinations of pipelines and/or pipeline segments.

### EXAMPLES

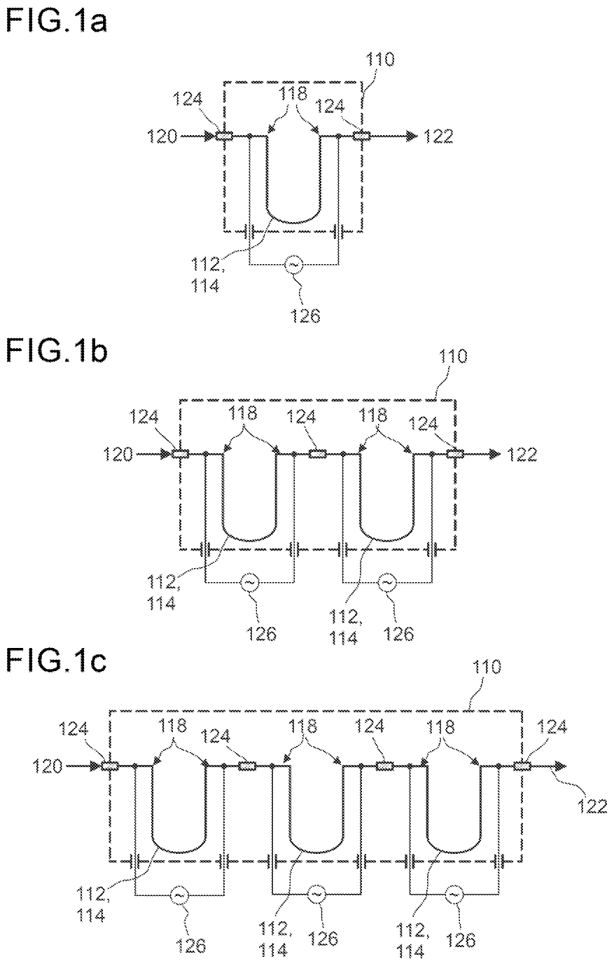

FIGS. 1a to 1c each show a schematic representation of an example of an apparatus 110 according to the invention for heating a fluid. The apparatus 110 comprises at least one electrically conductive pipeline 112 and/or at least one electrically conductive pipeline segment 114 for receiving the fluid. The fluid may be a gaseous and/or liquid medium. The fluid may for example be selected from the group consisting of: water, steam, a combustion air, a hydrocarbon mixture, a hydrocarbon to be cracked. For example, the fluid may be a hydrocarbon to be thermally cracked, in particular a mixture of hydrocarbons to be thermally cracked. For example, the fluid may be water or steam and additionally comprise a hydrocarbon to be thermally cracked, in particular a mixture of hydrocarbons to be thermally cracked. The fluid may for example be a preheated mixture of hydrocarbons to be thermally cracked and steam. Other fluids are also conceivable. The apparatus 110 may be designed to warm up the fluid, in particular to bring about a rise in the temperature of the fluid. For example, by the heating, the fluid may be heated to a prescribed or predetermined temperature value. For example, the fluid may be heated to a temperature in the range of 400° C. to 1200° C.

For example, the apparatus 110 may be part of an installation. For example, the installation may be selected from the group consisting of: a steam cracker, a steam reformer, a device for alkane dehydrogenation, a device for dry reforming. For example, the apparatus 110 may be designed for carrying out at least one process selected from the group consisting of steam cracking, steam reforming, alkane dehydrogenation, dry reforming. The apparatus 110 may for example be part of a steam cracker. The steam cracker may be designed for warming up the fluid to a temperature in the range of 550° C. to 1100° C. For example, the apparatus 110 may be part of a reformer furnace. For example, the fluid may be a combustion air of a reformer furnace which is prewarmed or heated up, for example to a temperature in the range of 200° C. to 800° C., preferably of 400° C. to 700° C. For example, the apparatus 110 may be part of a device for alkane dehydrogenation. The device for alkane dehydrogenation may be designed to warm up the fluid to a temperature in the range of 400° C. to 700° C. However, other temperatures and temperature ranges are also conceivable.

The pipeline 112 and/or the pipeline segment 114 may be designed to receive and transport the fluid. The pipeline 112 and/or the pipeline segment 114 may comprise at least one leg or a turn. The pipeline 112 may comprise at least one symmetrical pipe and/or at least one asymmetrical pipe. FIG. 1c shows an embodiment with three symmetrical pipeline 112 and/or pipeline segments 114. The geometry and/or surfaces and/or material of the pipeline 112 may be dependent on a fluid to be transported. The pipeline 112 and/or the pipeline segment 114 may be designed to conduct electrical current. The pipeline 112 may be designed as a reaction pipe of a reformer furnace.

FIG. 1a shows an example in which the apparatus has one pipeline 112. The apparatus 110 may have a plurality of pipelines 112 and/or pipeline segments 114, for example two, as shown in FIG. 1b, or three, as shown in FIG. 1c. The apparatus 110 may have L pipelines 112 and/or pipeline segments 114, where L is a natural number greater than or equal to two. For example, the apparatus 110 may have at least two, three, four, five or even more pipelines 112 and/or pipeline segments 114. The apparatus 110 may for example comprise up to a hundred pipelines 112 and/or pipeline segments 114. The pipelines 112 and/or pipeline segments 114 may be configured identically or differently. The pipelines 112 and/or pipeline segments 114 may be through-connected, and thus form a pipe system 118 for receiving the fluid. The pipe system 118 may comprise incoming and outgoing pipelines 112. The pipe system 118 may comprise at least one inlet 120 for receiving the fluid. The pipe system 118 may comprise at least one outlet 122 for discharging the fluid. FIG. 1 shows an embodiment in which the pipelines 112 and/or pipeline segments 114 are arranged and connected in such a way that the fluid flows through the pipelines 112 and/or pipeline segments 114 one after the other.

The pipelines 112 and/or pipeline segments 114 and correspondingly incoming and outgoing pipelines may be connected to one another in a fluid-conducting manner, while the pipelines 112 and/or pipeline segments 114 and the incoming and outgoing pipelines may be galvanically separated from one another. The apparatus 110 may comprise at least one galvanic separation, in particular at least one isolator 124, in particular a plurality of isolators 124. The galvanic separation between the respective pipelines 112 and/or pipeline segments 114 and the incoming and outgoing pipelines can be ensured by the isolators 124. The isolators 124 can ensure a free flow of the fluid.

The apparatus 110 has at least one single-phase AC power source and/or at least one single-phase AC voltage source 126. For example, the alternating current may be a sinusoidal alternating current. The single-phase AC power source and/or at least one single-phase AC voltage source 126 may be designed to provide an electrical current with a single phase.

The apparatus 110 has a forward conductor 128. The forward conductor 128 may be designed to conduct the alternating current generated to the pipeline 112 and/or the pipeline segment 114. The forward conductor 128 may be designed to apply the alternating current to the pipeline 112 and/or the pipeline segment 114 and/or to provide the alternating current for the pipeline 112 and/or for the pipeline segment 114. The forward conductor 128 may be designed to conduct the alternating current generated to the pipeline 112 and/or the pipeline segment 114 in such a way that the alternating current generated flows into the pipeline 112 and/or the pipeline segment 114 via the forward conductor 128. The forward conductor 128 may be a feeder.

The AC power source and/or the AC voltage source 126 are designed to generate an alternating current in the respective pipeline 112 and/or the respective pipeline segment 114. The alternating current generated can warm up the respective pipeline 112 and/or the respective pipeline segment 114 by Joulean heat, which is produced when the electrical current passes through conducting pipe material, for heating the fluid. Warming up the pipeline 112 and/or the pipeline segment 114 may comprise a change in a temperature of the pipeline 112 and/or the pipeline segment 114, in particular a rise in the temperature of the pipeline 112 and/or the pipeline segment 114.

The AC power source and/or AC voltage source 126 is connected to the pipeline 112 and/or the pipeline segment 114 in an electrically conducting manner in such a way that the alternating current generated flows into the pipeline 112 and/or the pipeline segment 114 via the forward conductor 128 and flows back to the AC power source and/or AC voltage source 126 via a return conductor 130. The return conductor 130 may be designed to carry away the alternating current after it has flowed through the pipeline 112 and/or the pipeline segment 114, in particular to the AC power source and/or AC voltage source 126.

The apparatus may comprise a plurality of single-phase AC power or single-phase AC voltage sources 126, for example three, as shown by way of example in FIG. 1c.

Each of the pipelines 112 and/or for each pipeline segment 114 can be assigned an AC power source and/or AC voltage source 126, which is connected to the respective pipeline 112 and/or to the respective pipeline segment 114, in particular electrically via at least one electrical connection.

To connect the single-phase AC or single-phase AC voltage sources 126 and the respective pipelines 112 and/or to the respective pipeline segments 114, the apparatus 110 can have two to N forward conductors 128 and two to N return conductors 130, where N is a natural number greater than or equal to three. The respective single-phase AC power source and/or AC voltage source 126 may be designed to generate an electrical current in the respective pipeline 112 and/or in the respective pipeline segment 114.

The AC power and/or AC voltage sources 126 may be either controlled or uncontrolled. The AC power and/or AC voltage sources 126 may be configured with or without the possibility of controlling at least one electrical output variable. For example, the apparatus may comprise at least one controller 127. The controller may be for example an external controller, that is to say a controller 127 arranged outside the reaction space. The apparatus 110 may comprise 2 to M different AC power and/or AC voltage sources 126, where M is a natural number greater than or equal to three. The AC power and/or AC voltage sources 126 may be electrically controllable independently of one another. For example, a different current may be generated in the respective pipelines 112 and/or in the respective pipeline segments 114 and different temperatures reached in the pipelines 112 and/or pipeline segments 114.

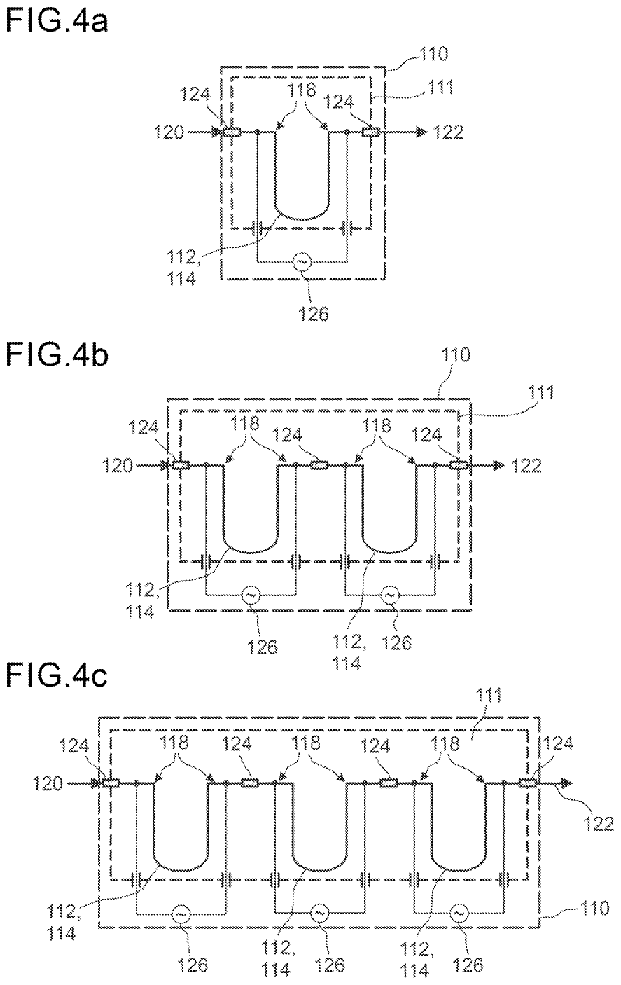

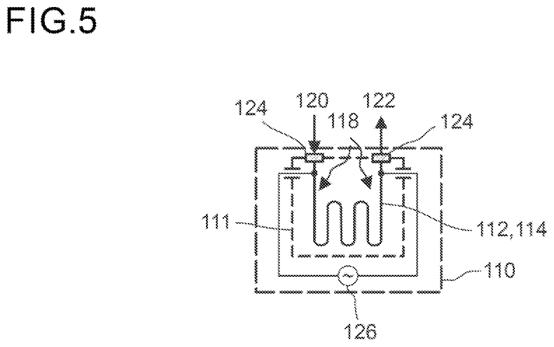

FIGS. 4a to 4c each show a schematic representation of an example of an apparatus 110 according to the invention for heating a fluid, a reactive space 111, also referred to as a reaction space, of the apparatus 110 also being shown in each of the examples in FIGS. 4a to 4c. With regard to the further elements of FIG. 4a, reference can be made to the description of FIG. 1a. With regard to the further elements of FIG. 4b, reference can be made to the description of FIG. 1b. With regard to the further elements of FIG. 4c, reference can be made to the description of FIG. 1c.

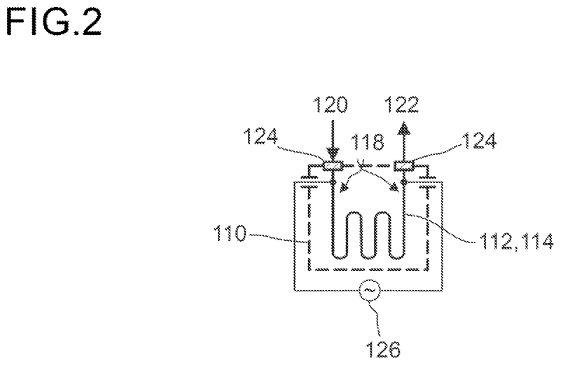

FIG. 2 shows a further embodiment of the apparatus 110 according to the invention. With regard to the configuration of the apparatus, reference is made to the description of FIG. 1 with the following special features. In this embodiment, the apparatus 110 has a pipeline 112 and/or pipeline segments 114 with three legs or turns, which are fluidically connected. The apparatus has the inlet 120 and the outlet 122. The fluid can flow through the pipeline 112 and/or the pipeline segments 114 in series from the inlet 120 to the outlet 122. For galvanic separation, the apparatus 110 can have the isolators 124, for example two isolators 124, as shown in FIG. 2. In this embodiment, the apparatus 110 has a single-phase AC power source and/or single-phase AC voltage source 126. To connect the single-phase AC power source and/or single-phase AC voltage source 126 and the pipeline 112 and/or to the respective pipeline segment 114, the apparatus 110 can have a forward conductor 128 and a return conductor 130.

FIG. 5 shows a schematic representation of an example of an apparatus 110 according to the invention for heating a fluid, a reactive space 111 of the apparatus 110 also being shown in the example of FIG. 5. With regard to the further elements of FIG. 5, reference can be made to the description of FIG. 2.

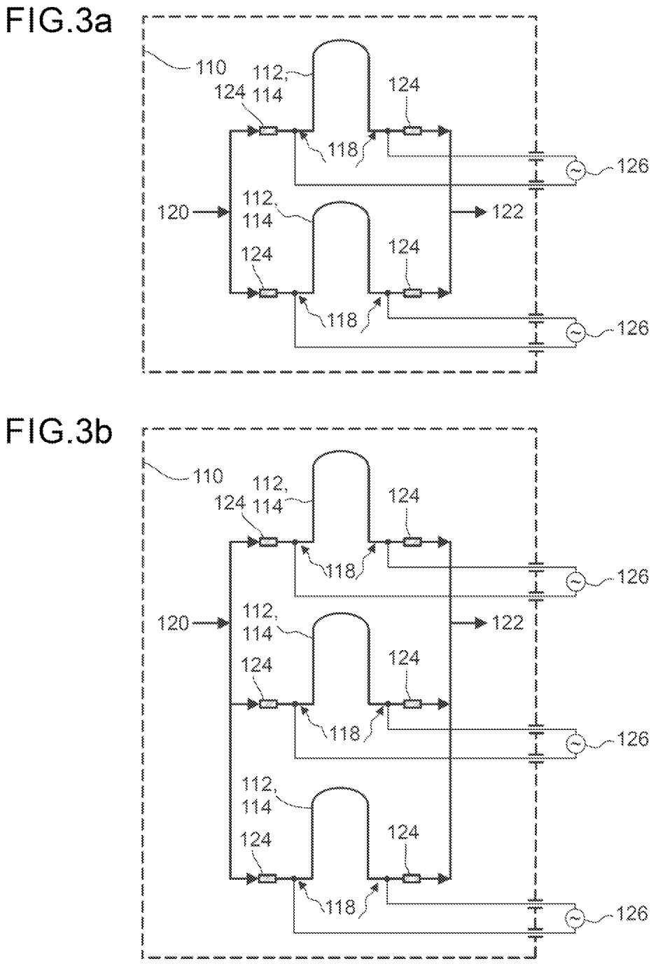

In the examples of FIGS. 1a and 1c, the pipelines 112 are arranged in series. FIGS. 3a and 3b show embodiments with pipelines 112 and/or pipeline segments 114 connected in parallel, in FIG. 3a with two parallel pipeline 112 and/or pipeline segments 114 and in FIG. 3b with 3 parallel pipelines 112 and/or pipeline segments 114. Other numbers of parallel pipelines 112 and/or pipeline segments 114 are also conceivable. In FIGS. 3a and 3b, the apparatus 110 has an inlet 120 and an outlet 122. The pipelines 112 and/or pipeline segments 114 can be connected to one another in such a way that the fluid can flow through at least two pipelines 112 and/or pipeline segments 114 in parallel. The pipelines 112 and/or pipeline segments 114 connected in parallel can have different geometries and/or surfaces and/or materials from one another. For example, the pipelines 112 and/or pipeline segments 114 connected in parallel can have different numbers of legs or turns.

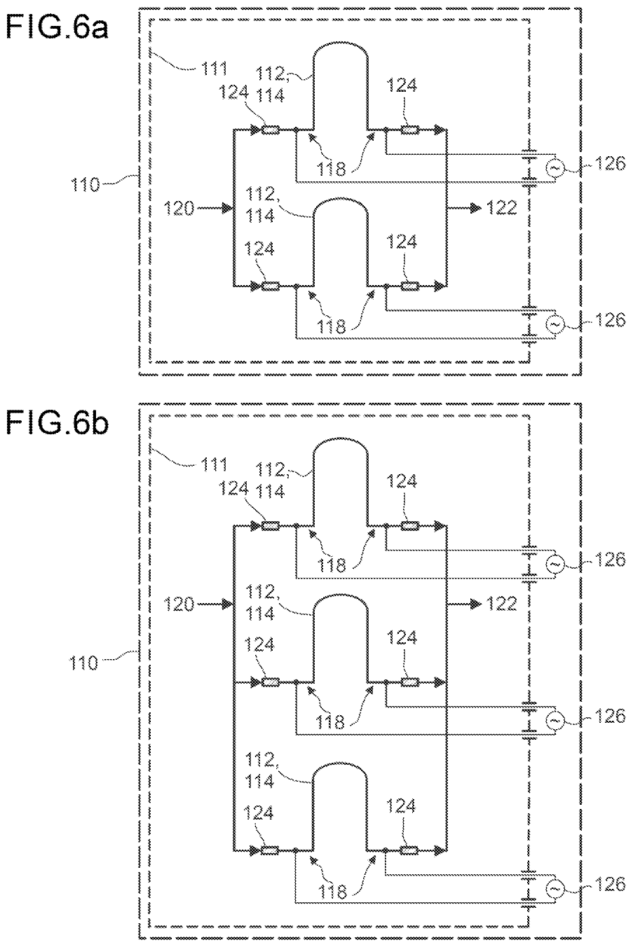

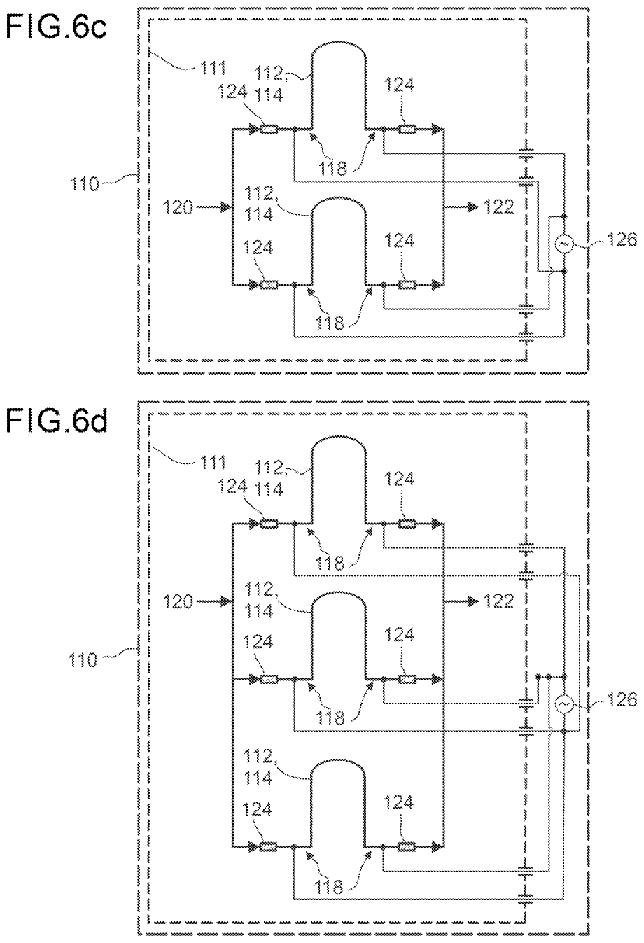

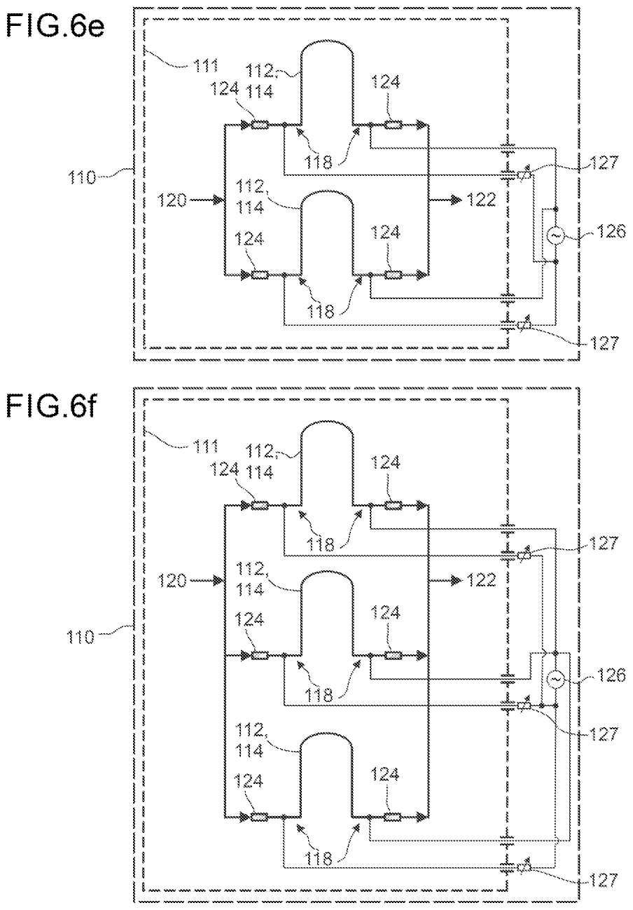

FIGS. 6a and 6b show a schematic representation of an example of an apparatus 110 according to the invention for heating a fluid, a reactive space 111 of the apparatus 110 also being shown in each of the examples of FIGS. 6a and 6b. With regard to the further elements of FIG. 6a, reference can be made to the description of FIG. 3a. With regard to the further elements of FIG. 6b, reference can be made to the description of FIG. 3b. With regard to FIGS. 6c and 6e, reference can be made to the description of FIG. 6A. In the embodiments of FIGS. 6c and 6e, the pipeline 112 and/or pipeline segments 114 share a common AC power source and/or AC voltage source 126. In the embodiment of FIG. 6e, the apparatus also has a controller 127. The controller 127 may be designed to control the output variable of the AC power source and/or AC voltage source 126, so that the pipeline 112 and/or pipeline segments 114 can have controllable temperatures, in particular different temperatures. With regard to FIGS. 6d and 6f, reference can be made to the description of FIG. 6b. In the embodiments of FIGS. 6d and 6f, the pipeline 112 and/or pipeline segments 114 share a common AC power source and/or AC voltage source 126. In the embodiment of FIG. 6f, the apparatus also has a controller 127.

The apparatus 110 can have symmetrical and/or asymmetrical pipes and/or combinations thereof. In a purely symmetrical configuration, the apparatus 110 can have pipelines 112 and/or pipeline segments 114 of an identical type of pipe. The apparatus 110 can have any combination of types of pipe, which may for example also be connected as desired in parallel or in series. The type of pipe may be characterized at least by one feature selected from the group consisting of: a horizontal configuration of the pipeline 112 and/or the pipeline segment 114; a vertical configuration of the pipeline 112 and/or the pipeline segment 114; a length in the inlet (L1) and/or outlet (L2) and/or transition (L3); a diameter in the inlet (d1) and outlet (d2) and/or transition (d3); the number n of passes; the length per pass; the diameter per pass; the geometry; the surface; and the material. Alternatively or additionally, the type of pipe may be selected from at least one pipeline 112 and/or at least one pipeline segment 114 with or without galvanic separation and/or grounding 125. The galvanic separation may for example be configured using an isolator 124. For example, a galvanic separation may be provided at the inlet 120 of the pipeline 112 and/or the pipe segment 114 and a galvanic separation may be provided at the outlet 122 of the pipeline 112 and/or the pipe segment 114. For example, a galvanic separation may be provided at the inlet 120 of the pipeline 112 and/or the pipe segment 114 and a grounding 125 may be provided at the outlet 122 of the pipeline 112 and/or the pipe segment 114. For example, a galvanic separation may only be provided at the inlet 120 of the pipeline 112 and/or of the pipe segment 114. For example, a grounding 125 may only be provided at the inlet 120 of the pipeline 112 and/or of the pipe segment 114. For example, the pipeline 112 and/or the pipe segment 114 may be provided without grounding 125 at inlet 120 and outlet 122 and/or without galvanic separation at inlet 120 and outlet 122. Alternatively or additionally, the type of pipe may be characterized by a direction of flow of the fluid. The fluid can in principle flow in two directions of flow, referred to as the first and second directions of flow. The first and second directions of flow can be opposite.

Alternatively or additionally, the type of pipe may be characterized by the application of alternating current to the pipeline 112 and/or the pipeline segment 114. For example, a forward conductor 128 may be connected midway along the pipeline 112 and/or the pipe segment 114. The return conductors 130 may be connected to the beginnings or ends of the pipeline 112 and/or the pipe segment 114. For example, the forward conductor 128 may be connected at the beginning of the pipeline 112 and/or the pipe segment 114 and the return conductor 130 at the end of the pipeline 112 and/or the pipe segment 114.

Any combination of the types of pipe is possible.

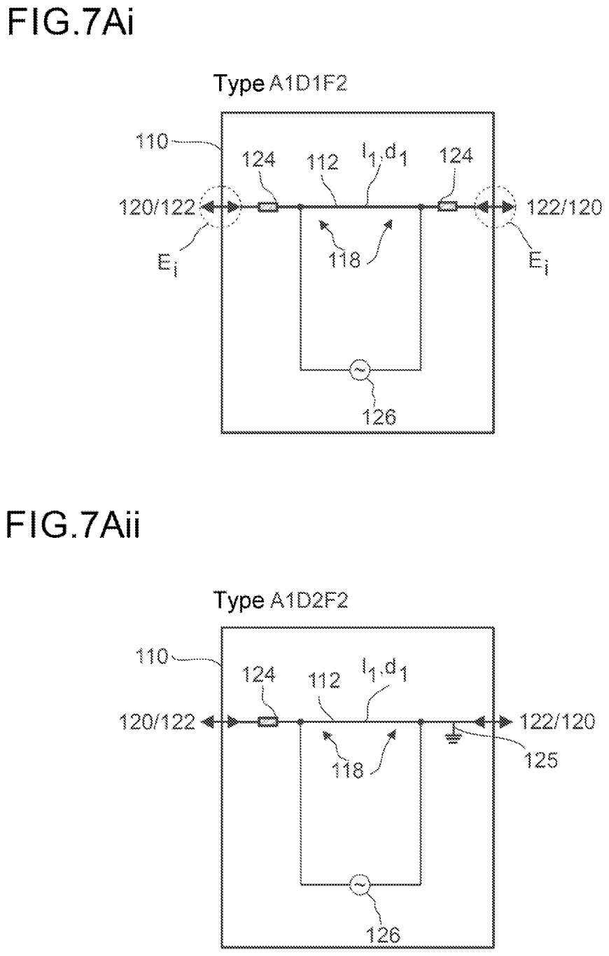

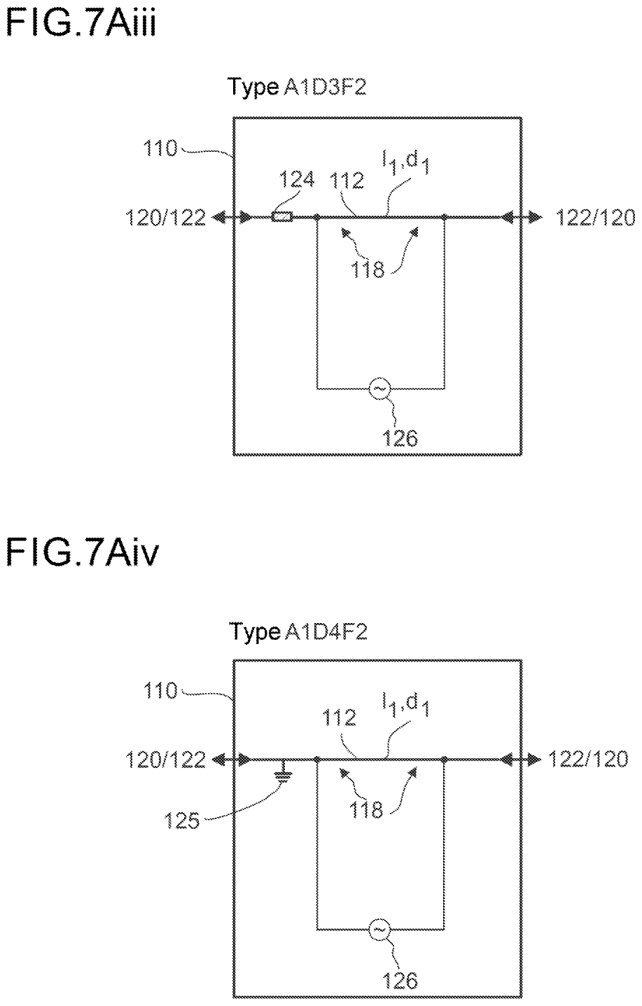

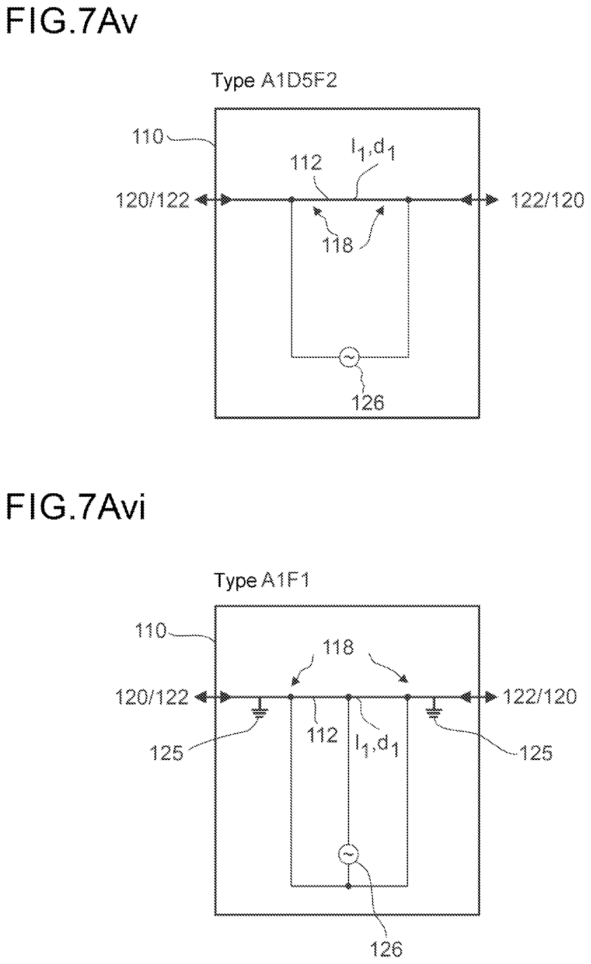

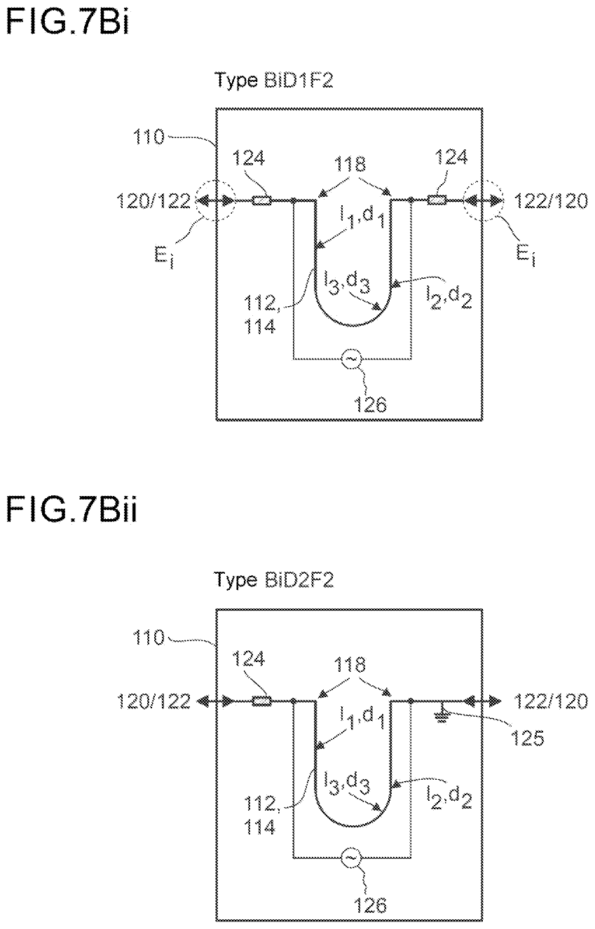

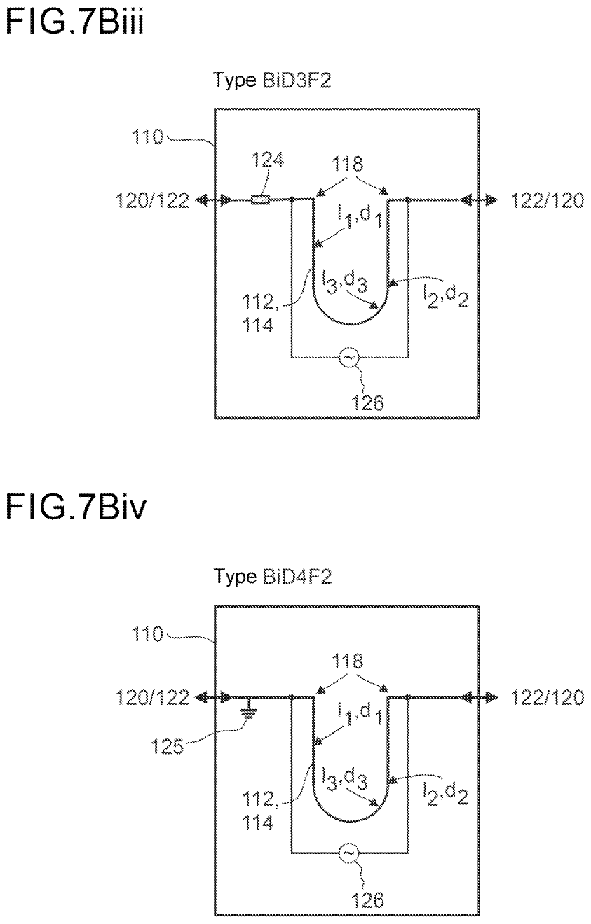

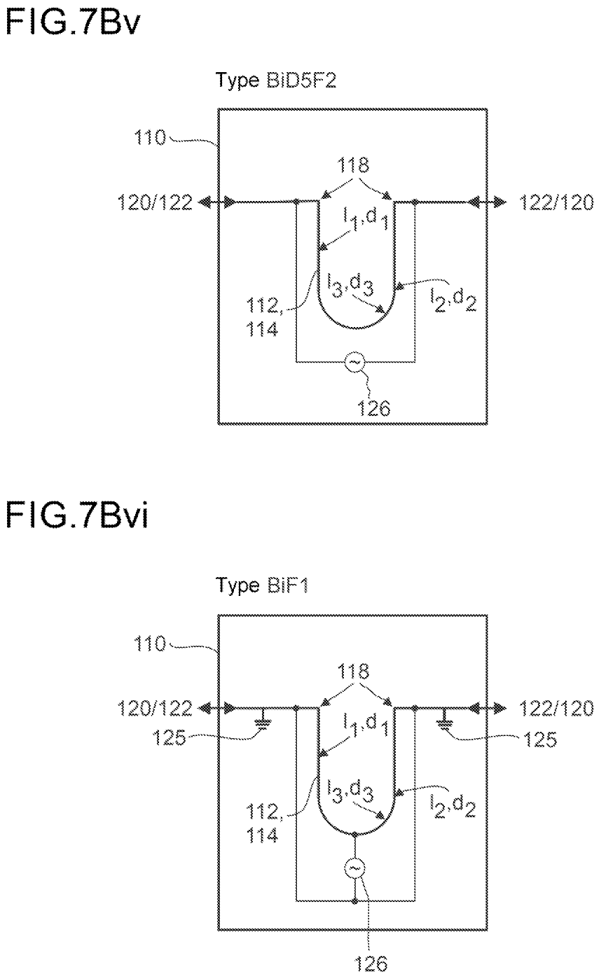

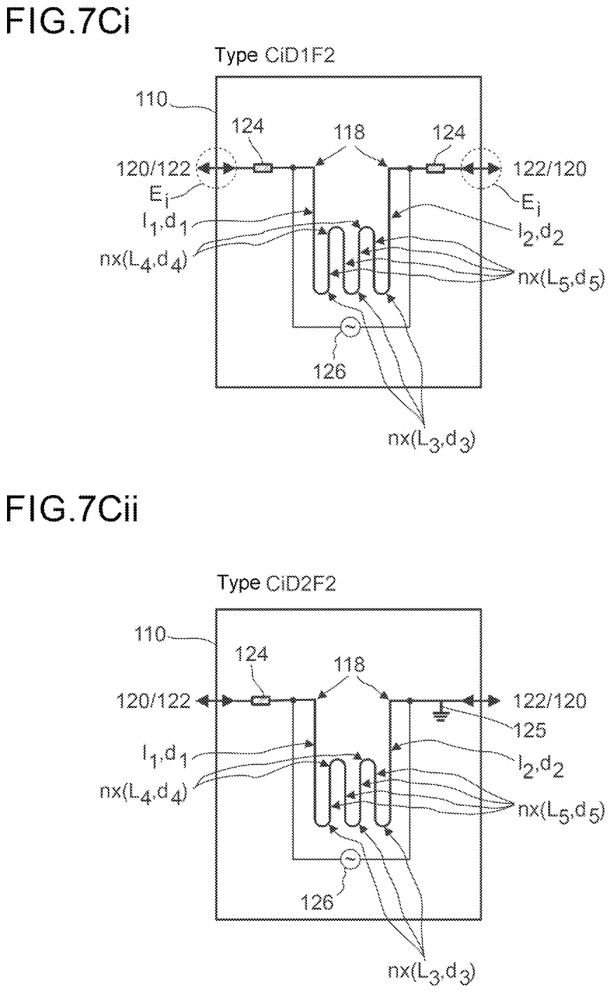

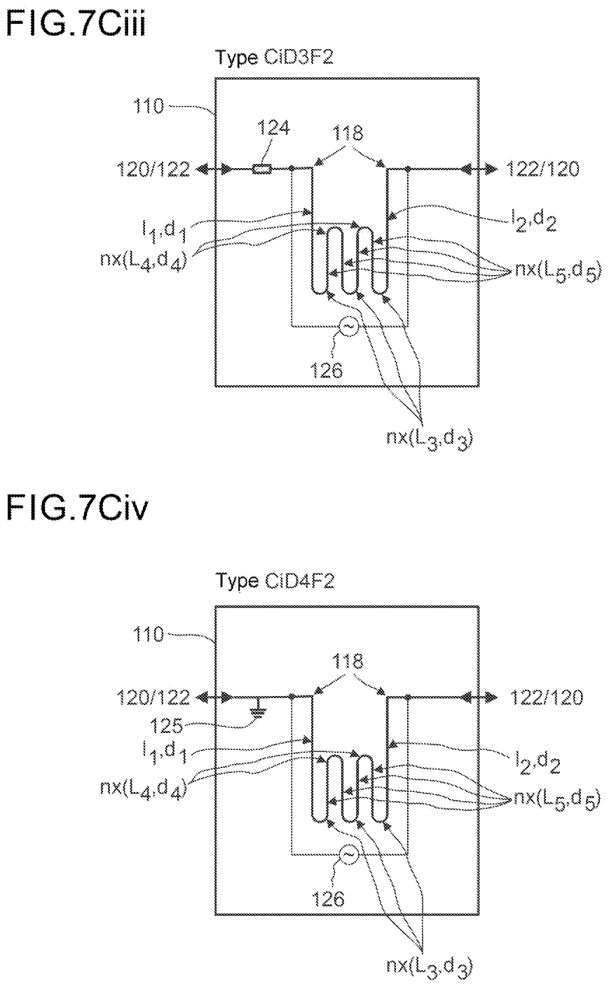

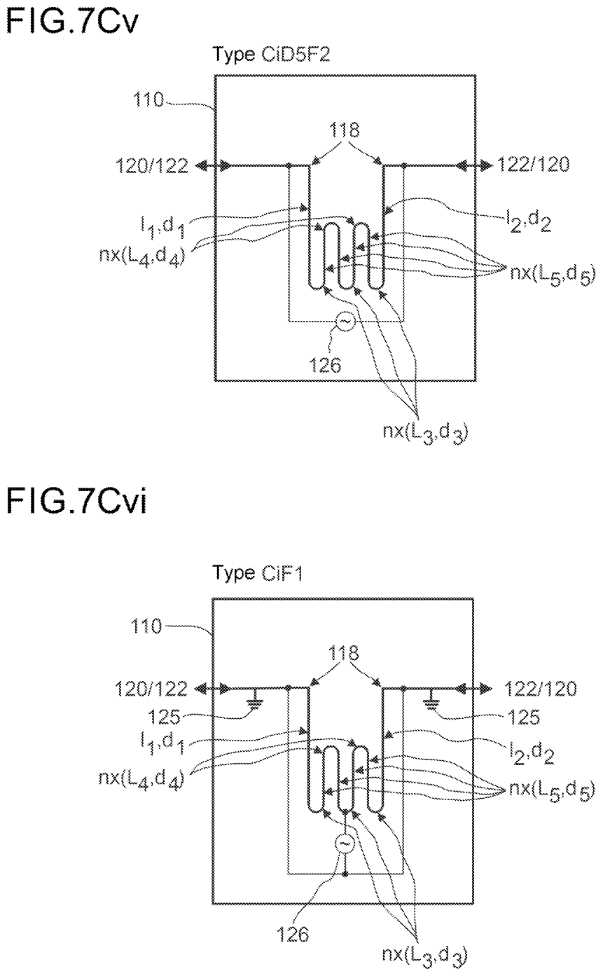

FIGS. 7Ai to Civ show exemplary possible embodiments of types of pipe in a schematic representation. The type of pipe is indicated in each of FIGS. 7A1 to Civ. This can be divided into the following categories, whereby all conceivable combinations of categories are possible:
Category A indicates a course of the pipeline 112 and/or a pipeline segment 114, where A1 denotes a type of pipe with a horizontal course and A2 a type of pipe with a vertical course, i.e. a course perpendicular to the horizontal course.
Category B specifies a ratio of lengths in the inlet (L1) and/or outlet (L2) and/or diameter in the inlet (d1) and/or outlet (d2) and/or transition (d3), with six different possible combinations provided in the construction kit 138.
Category C indicates ratios of lengths in the inlet (L1) and/or outlet (L2) and lengths of passes. All commutations are conceivable here which are marked with Ci in the present case.
Category D indicates whether the at least one pipeline 112 and/or the at least one pipeline segment 114 is configured with or without galvanic separation and/or grounding 125. The galvanic separation may for example be configured using an isolator 124. D1 denotes a type of pipe in which a galvanic separation is provided at the inlet 120 of the pipeline 112 and/or the pipe segment 114 and a galvanic separation is provided at the outlet 122 of the pipeline 112 and/or the pipe segment 114. D2 denotes a type of pipe in which a galvanic separation is provided at the inlet 120 of the pipeline 112 and/or the pipe segment 114 and a grounding 125 is provided at the outlet 122 of the pipeline 112 and/or the pipe segment 114. D3 denotes a type of pipe in which a galvanic separation is only provided at the inlet 120 of the pipeline 112 and/or the pipe segment 114. D4 denotes a type of pipe in which a grounding 125 is only provided at the inlet 120 of the pipeline 112 and/or the pipe segment 114. D5 denotes a type of pipe in which the pipeline 112 and/or the pipe segment 114 is provided without grounding 125 at the inlet 120 and outlet 122 and/or without galvanic separation at the inlet 120 and outlet 122.
Category E indicates a direction of flow of the fluid. The fluid can in principle flow in two directions. A type of pipe in which the fluid flows in a first direction of flow is referred to as type of pipe E1, and a type of pipe in which the fluid flows in a second direction of flow is referred to as type of pipe E2. The first and second directions of flow can be opposite.
Category F identifies the application of alternating current to the pipeline 112 and/or the pipe segment 114. F1 denotes a connection of a forward conductor 128 midway along the pipeline 112 and/or the pipe segment 114, the return conductors 130 being connected to the beginnings or ends of the pipeline 112 and/or the pipe segment 114. F2 denotes a connection of the forward conductor 128 at the beginning of the pipeline 112 and/or the pipe segment 114 and of the return conductor 130 at the end of the pipeline 112 and/or the pipe segment 114.

In FIG. 7Ai, a pipeline 112 and/or a pipeline segment 114 of the type of pipe A1D1F2 is shown. The pipeline 112 and/or the pipeline segment 114 has a horizontal course. In this embodiment, the apparatus 110 has two isolators 124, which are arranged after the inlet 120 and before the outlet 122. With regard to the further elements of FIG. 7Ai, reference can be made to the description of FIG. 4a. In FIG. 7Ai, possible directions of flow Ei are shown by way of example by a double-headed arrow at inlet 120 and outlet 122. In the further FIGS. 7, inlet 120 and outlet 122 are denoted together. The example in FIG. 7Aii shows a type of pipe A1D2F2 and differs from FIG. 7Ai in that the apparatus 110 has only one isolator 124, a grounding 125 being provided instead of the second isolator. The example in FIG. 7Aiii shows a type of pipe AiD3F2 and differs from FIG. 7Aii in that no grounding 125 is provided.

In FIG. 7Aiv, type of pipe A1D4F2, the apparatus 110 has in comparison with FIG. 7Aiii only a grounding 125 instead of the isolator. Embodiments without isolators 124 or groundings 125 are also possible, as shown in FIG. 7Av, type of pipe A1D5F2. FIGS. 7Ai to 7Avi show type of pipes in which the alternating current is fed in via a connection of the forward conductor 128 at the beginning of the pipeline 112 and/or the pipe segment 114. FIG. 7Avi shows a type of pipe A1F1 in which the alternating current is fed in midway along the pipeline 112 and/or the pipe segment 114.

In FIG. 7Bi, type of pipe BiD1F2, lengths in the inlet (L1), outlet (L2) and transition (L3) and diameters in the inlet (d1), outlet (d2) and transition (d3) are shown. The apparatus 110 may comprise pipelines 112 and/or pipeline segments 114 with different lengths in the inlet (L1) and/or outlet (L2) and/or transition (L3) and/or diameters in the inlet (d1) and/or outlet (d2) and/or transition (d3). With regard to the further elements of FIG. 7Bi, reference can be made to the description of FIG. 4a. The example in FIG. 7Bii shows a type of pipe BiD2F2 and differs from FIG. 7Bi in that the apparatus 110 has only one isolator 124, a grounding 125 being provided instead of the second isolator. The example in FIG. 7Biii shows a type of pipe BiD3F2 and differs from FIG. 7Bii in that no grounding 125 is provided. In FIG. 7Biv, type of pipe BiD4F2, the apparatus 110 has in comparison with FIG. 7Biii only a grounding 125 instead of the isolator. Embodiments without isolators 124 or groundings 125 are also possible, as shown in FIG. 7Bv, type of pipe BiD5F2. FIGS. 7Bi to 7Bvi show type of pipes in which the alternating current is fed in via a connection of the forward conductor 128 at the beginning of the pipeline 112 and/or the pipe segment 114. FIG. 7Bvi shows a type of pipe BiF1 in which the alternating current is fed in midway along the pipeline 112 and/or the pipe segment 114.

FIG. 7Ci, type of pipe CiD1F2, shows an example in which the apparatus 110 has pipelines 112 and/or pipeline segments 114 with a plurality n of passes, for example three, as shown here. The passes may each have different lengths L3, L4, L5 and/or diameters d3, d4, d5. With regard to the further elements of FIG. 7Ci, reference can be made to the description of FIG. 5. The example in FIG. 7Cii shows a type of pipe CiD2F2 and differs from FIG. 7Ci in that the apparatus 110 has only one isolator 124, a grounding 125 being provided instead of the second isolator. The example in FIG. 7Ciii shows a type of pipe CiD3F2 and differs from FIG. 7Cii in that no grounding 125 is provided. In FIG. 7Civ, type of pipe CiD4F2, the apparatus 110 has in comparison with FIG. 7Ciii only a grounding 125 instead of the isolator. Embodiments without isolators 124 or groundings 125 are also possible, as shown in FIG. 7Cv, type of pipe CiD5F2. FIGS. 7Ci to 7Cvi show type of pipes in which the alternating current is fed in via a connection of the forward conductor 128 at the beginning of the pipeline 112 and/or the pipe segment 114. FIG. 7Cvi shows a type of pipe CiF1 in which the alternating current is fed in midway along the pipeline 112 and/or the pipe segment 114.

The apparatus 110 may comprise a combination of at least two different types of pipe which are connected in parallel and/or in series. For example, the apparatus 110 may comprise pipelines 112 and/or pipeline segments 114 of different lengths in the inlet (L1) and/or outlet (L2) and/or transition (L3). For example, the apparatus may comprise pipelines and/or pipeline segments with an asymmetry of the diameters in the inlet (d1) and/or outlet (d2) and/or transition (d3). For example, the apparatus 110 may comprise pipelines 112 and/or pipeline segments 114 with a different number of passes. For example, the apparatus 110 may comprise pipelines 112 and/or pipeline segments 114 with passes with different lengths per pass and/or different diameters per pass.

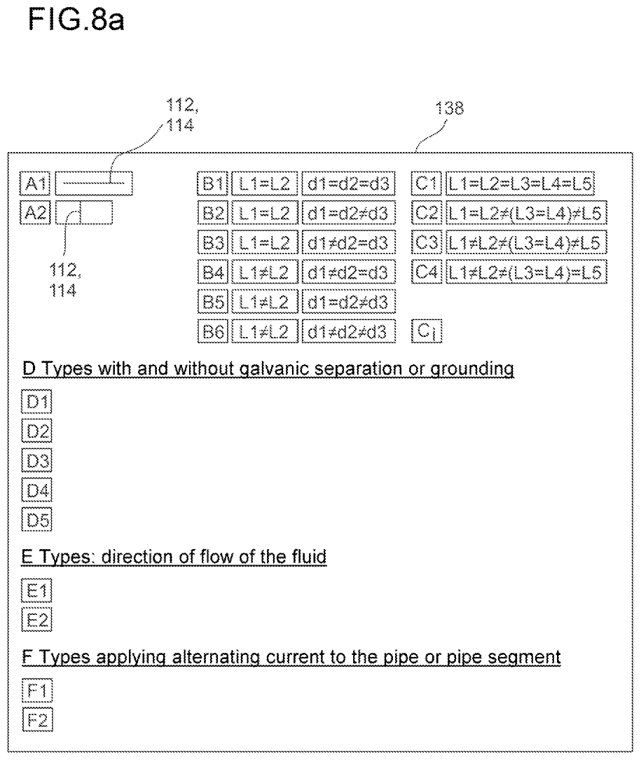

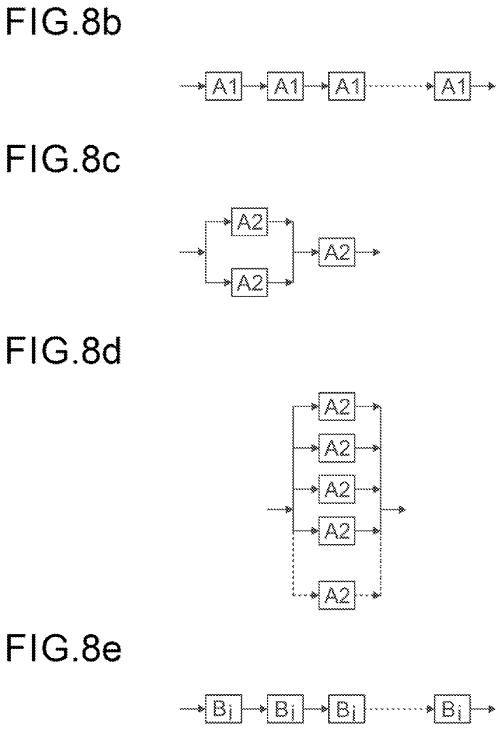

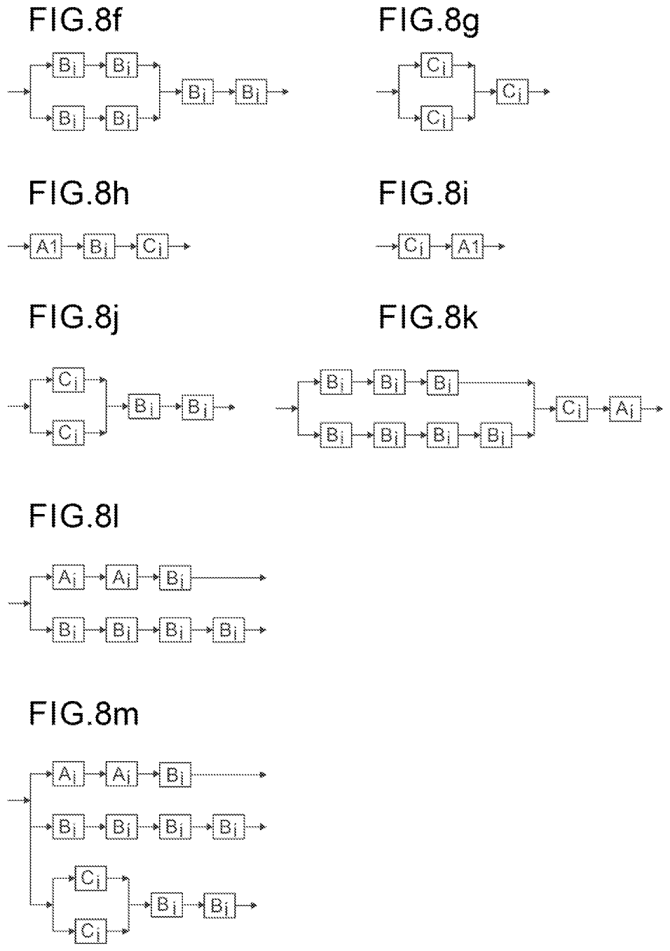

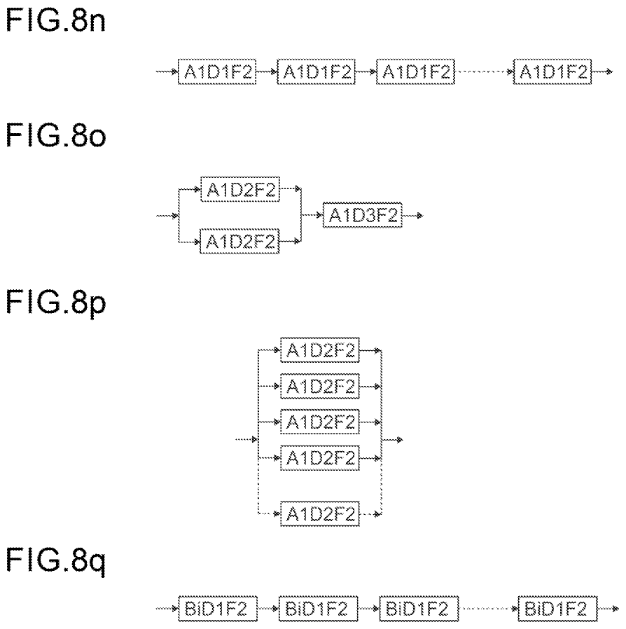

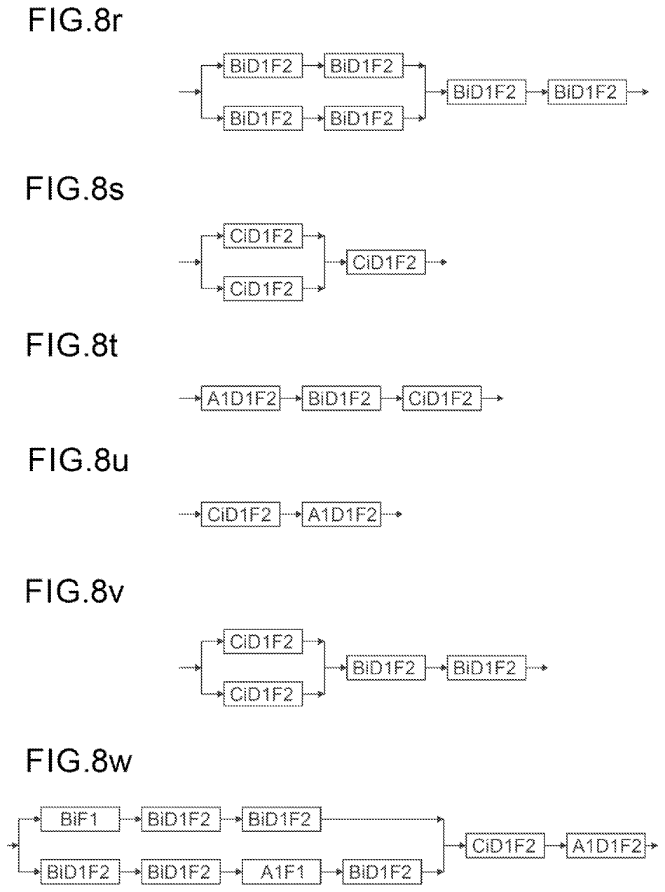

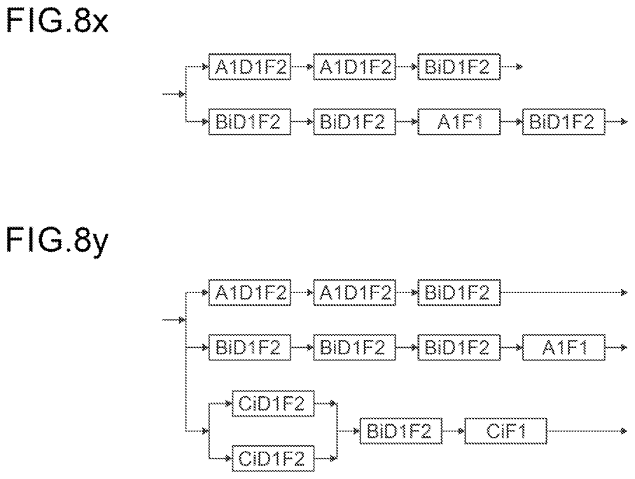

In principle, any combinations of all types of pipe in parallel and/or in series are possible. Pipelines 112 and/or pipeline segments 114 can be present in various types of pipe in the form of a construction kit 138 and may be selected and combined as desired, dependent on an intended use. FIG. 8a shows an embodiment of a construction kit 138 with different types of pipe. FIGS. 8b to y show examples according to the invention of combinations of pipelines 112 and/or pipeline segments 114 of the same and/or different type of pipe. FIG. 8b shows an example with three horizontal pipelines 112 and/or pipeline segments 114 of type of pipe A1, which are arranged one after the other. FIG. 8c shows two vertical pipes of type of pipe A2 connected in parallel and one downstream pipeline 112 and/or a downstream pipeline segment 114 also of type of pipe A2. In FIG. 8d, a plurality of pipelines 112 and/or pipeline segments 114 of the type of pipe A2 are shown, which are all connected in parallel. FIG. 8e shows an embodiment in which a plurality of types of pipe of category B are arranged one after the other. The pipelines 112 and/or pipeline segments 114 can be identical or different type of pipe of category B, which is identified by Bi. FIG. 8f shows an embodiment with six pipelines 112 and/or pipeline segments 114 of category B, two pipelines 112 and/or pipeline segments 114 being arranged in two parallel strands and two further pipelines 112 and/or pipeline segments 114 being connected downstream. FIG. 8g shows an embodiment with pipelines 112 and/or pipeline segments 114 of category C, two pipelines 112 and/or pipeline segments 114 connected in parallel and one pipeline 112 and/or one pipeline segment 114 connected downstream. Mixed forms of categories A, B and C are also possible, as shown in FIGS. 8h to m. The apparatus 110 may have a plurality of feed inlets and/or feed outlets and/or production streams. The pipelines 112 and/or pipeline segments 114 of different or identical type of pipes can be arranged in parallel and/or in series with a plurality of feed inlets and/or feed outlets, as shown for example in FIGS. 8k and 8m.

FIGS. 8n to 8p show an exemplary combination of pipelines 112 and/or pipeline segments 114 of categories A, D and F. FIGS. 8q and 8r show an exemplary combination of pipelines 112 and/or pipeline segments 114 of categories B, D and F. FIG. 8s shows an exemplary combination of pipelines 112 and/or pipeline segments 114 of categories C, D and F. FIG. 8t shows an exemplary combination of pipelines 112 and/or pipeline segments 114 of categories A, D and F. FIG. 8u shows an exemplary combination of pipelines 112 and/or pipeline segments 114 of categories A, C, D and F. FIG. 8v shows an exemplary combination of pipelines 112 and/or pipeline segments 114 of categories B, C, D and F. FIGS. 8w and 8y show exemplary combinations of pipelines 112 and/or pipeline segments 114 of categories A, B, C, D and F. FIG. 8x shows an exemplary combination of pipelines 112 and/or pipeline segments 114 of categories A, B, D and F. The apparatus 110 may comprise a plurality of feed inlets and/or feed outlets and/or production streams. The pipelines 112 and/or pipeline segments 114 of different or identical types of pipe of categories A, B, C, D, E and F can be arranged in parallel and/or in series with a plurality of feed inlets and/or feed outlets. Examples of a plurality of feed inlets and/or feed outlets and/or production streams are shown in FIGS. 8o, 8p, 8r, 8s, 8v to 8y.

By using pipelines 112 and/or pipeline segments 114 of different types of pipe, more accurate temperature control and/or an adaptation of the reaction when there is a fluctuating feed and/or a selective yield of the reaction and/or an optimized process technology can be made possible.

### LIST OF REFERENCE SIGNS

110 Apparatus
111 Reactive space
112 Pipeline
114 Pipeline segment
118 Pipe system
120 Inlet
122 Outlet
124 Isolator
125 Grounding
126 Single-phase AC power source and/or AC voltage source
127 Controller
128 Forward conductor
130 Return conductor
132 Heating wire
134 First pipeline
136 Second pipeline
138 Construction kit

1.-14. (canceled)

15. An apparatus (110) for heating a fluid comprising
at least one electrically conductive pipeline (112) and/or at least one electrically conductive pipeline segment (114) for receiving the fluid, and
at least one single-phase AC power source and/or at least one single-phase AC voltage source (126), each pipeline (112) and/or each pipeline segment (114) being assigned a single-phase AC power source and/or a single-phase AC voltage source (126) which is connected to the respective pipeline (112) and/or to the respective pipeline segment (114), the respective single-phase AC power source and/or single-phase AC voltage source (126) being designed to generate an electrical current in the respective pipeline (112) and/or in the respective pipeline segment (114), which warms up the respective pipeline (112) and/or the respective pipeline segment (114) by Joulean heat, which is produced when the electrical current passes through conducting pipe material, for heating the fluid, the single-phase AC power source and/or the single-phase AC voltage source (126) being connected to the pipeline (112) and/or the pipeline segment (114) in an electrically conducting manner in such a way that the alternating current generated flows into the pipeline (112) and/or the pipeline segment (114) via a forward conductor (128) and flows back to the AC power source and/or AC voltage source (126) via a return conductor (130),
the apparatus (110) comprising a plurality of pipelines (112) and/or pipeline segments (114), the pipelines (112) and/or pipeline segments (114) being through-connected and thus forming a pipe system for receiving the fluid, the pipelines (112) and/or pipeline segments (114) and correspondingly incoming and outgoing pipelines being connected to one another in a fluid-conducting manner, the pipelines (112) and/or pipe segments (114) and the incoming and outgoing pipelines (112) being galvanically separated from one another.

16. The apparatus (110) according to claim 15, wherein the apparatus (110) comprises L pipelines (112) and/or pipeline segments (114), where L is a natural number greater than or equal to two, the pipelines (112) and/or pipeline segments (114) comprising symmetrical or asymmetrical pipes and/or a combination thereof.

17. The apparatus (110) according to claim 15, wherein the apparatus (110) comprises isolators (124) which are designed for galvanic separation between the respective pipelines (112) and/or pipeline segments (114) and the incoming and outgoing pipelines, the isolators (124) being designed to ensure a free through-flow of the fluid.

18. The apparatus (110) according to claim 15, wherein a number or all of the pipelines (112) and/or pipeline segments (112) are configured in series and/or in parallel.

19. The apparatus (110) according to claim 15, wherein the apparatus (110) comprises a plurality of single-phase AC power or single-phase AC voltage sources (126), the single-phase AC power and/or single-phase AC voltage sources (126) being configured with or without the possibility of controlling at least one electrical output variable.

20. The apparatus (110) according to claim 19, wherein, to connect the single-phase AC power or single-phase AC voltage sources (126) and the respective pipelines (112) and/or with the respective pipeline segments (114), the apparatus (110) comprises 2 to N forward conductors (128) and 2 to N return conductors (130), where N is a natural number greater than or equal to three.

21. The apparatus (110) according to claim 19, wherein the respective single-phase AC power or single-phase AC voltage sources (126) are configured identically or differently.

22. The apparatus (110) according to claim 21, wherein the apparatus (110) comprises 2 to M different single-phase AC power and/or single-phase AC voltage sources (126), where M is a natural number greater than or equal to three, the single-phase AC power and/or single-phase AC voltage sources (126) being electrically controllable independently of one another.

23. An installation comprising at least one apparatus (110) according to claim 15.

24. The installation according to claim 23, wherein the installation is selected from the group consisting of: a steam cracker, a steam reformer, a device for alkane dehydrogenation, a device for dry reforming.

25. A method for heating a fluid by using an apparatus (110) according to claim 15 relating to an apparatus, the method comprising the following steps:
providing at least one electrically conductive pipeline (112) and/or at least one electrically conductive pipeline segment (114) for receiving the fluid;
receiving the fluid in the pipeline (112) and/or the pipeline segment (114);
providing at least one single-phase AC power source and/or at least one single-phase AC voltage source (126), each pipeline (112) and/or each pipeline segment (114) being assigned a single-phase AC power source and/or a single-phase AC voltage source (126) which is connected to the respective pipeline (112) and/or to the respective pipeline segment (114),
generating by the respective single-phase AC power source and/or single-phase AC voltage source (126) an electrical current in the respective pipeline (112) and/or in the respective pipeline segment (114), which warms up the respective pipeline (112) and/or the respective pipeline segment (114) by Joulean heat, which is produced when the electrical current passes through conducting pipe material, for heating the fluid, the single-phase AC power source and/or the single-phase AC voltage source (126) being connected to the pipeline (112) and/or the pipeline segment (114) in an electrically conducting manner in such a way that the alternating current generated flows into the pipeline (112) and/or the pipeline segment (114) via a forward conductor (128) and flows back to the AC power source and/or AC voltage source (126) via a return conductor (130).

26. The method according to claim 25, wherein, as the fluid, a hydrocarbon to be thermally cracked, is heated.

27. The method according to claim 15 relating to a method, wherein, as the fluid, water or steam is heated, with said water or said steam being heated in particular to a temperature in the range of 550° C. to 700° C., and the fluid additionally comprising a hydrocarbon to be thermally cracked, in particular a mixture of hydrocarbons to be thermally cracked, the fluid to be heated being a preheated mixture of hydrocarbons to be thermally cracked and steam.

28. The method according to claim 15 relating to a method, wherein, as the fluid, combustion air of a reformer furnace is preheated, for example to a temperature in the range of 200° C. to 800° C., preferably 400° C. to 700° C.
